(19) United States
(12) Patent Application Publication
(10) Pub. No.: US 2008/0317105 A1
(43) Pub. Date: Dec. 25, 2008

(54) Low-current radio-frequency transceiver for use in short-range duplex communications applications

(75) Inventors: Arthur L. Cohen, Mountain View, CA (US); John Glissman, Valley Ford, CA (US); Marvin Vickers, Quincy, CA (US); Noel Marshall, Gerringong (AU); John Haggis, San Jose, CA (US)

Correspondence Address: STAINBROOK & STAINBROOK, LLP, 412 AVIATION BOULEVARD, SUITE H, SANTA ROSA, CA, 95403, US

(73) Assignee: AERIELLE, INC., Mountain View, CA (US)

(21) Appl. No.: 11/465,105

(22) Filed: Aug. 16, 2006

Related U.S. Application Data
(60) Provisional application No. 60/708,556, filed on Aug. 16, 2005.

(51) Int. Cl. H04B 1/38

(52) U.S. Cl. 375/219; 455/73

(57) ABSTRACT

A low-current transceiver, powered by two small low-voltage batteries, for use in wireless headset/phoneset applications, such as hands-free headsets used with cellular telephones. Re-use of current from at least one circuit to provide power to at least one other power-consuming element of the transceiver, along with interrupt-driven control of the current made available to transmit and receive circuits, enables extended battery life (e.g., 120 hours). The headset/phoneset circuits incorporate a technique that draws an extremely low supply current from two low-voltage batteries while providing clear two-way communication over a range of about 3 meters.

### CROSS REFERENCES TO RELATED APPLICATIONS

The present application claims the benefit of U.S. Provisional Application Ser. No. 60/708,556, filed Aug. 16, 2005 (Aug. 16, 2005).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to radio-frequency (RF) transceivers, and more particularly to an improved battery-powered RF transceiver apparatus for use in wireless headsets, wireless computer keyboards and mice, and any other application that requires a battery-powered transceiver that communicates over a distance of a few meters.

2. Discussion of Related Art Including Information Disclosed Under 37 CFR §§1.97, 1.98

The use of wireless cell phones has become commonplace in the U.S. and throughout the world. The use of cell phones in an automobile and while doing other mobile activities is very common. Because of the distractions associated with cell phone use, many states in the United States require use of “hands free” devices. Most of these devices are wired headsets connected to the cell phone. Although functional, users have found them to be frustrating to use during everyday activities. Consequently, there is a need for a wireless headset that connects to the cell phone. Current wireless headset devices, however, are troubled with poor quality of sound and lack of a low-power solution enabling reasonable talk time for the headset or phoneset. As an example, Bluetooth-enabled headsets today only provide between 3-6 hrs of talk time on new rechargeable batteries.

These same issues exist for other wireless transceiver applications, such as the wireless computer keyboard and mouse, the wireless headset/phoneset for a landline phone and the wireless remote control.

In general, there is a need for a low-power transceiver that operates on commonly available low-voltage batteries, and extends transceiver battery life between recharge events.

The foregoing discussion reflects the current state of the art of which the present inventors are aware. Reference to, and discussion of, this information is intended to aid in discharging Applicant's acknowledged duty of candor in disclosing information that may be relevant to the examination of claims to the present invention. However, it is respectfully submitted that no prior art patents or other references disclose, teach, suggest, show, or otherwise render obvious, either singly or when considered in combination, the invention described and claimed herein.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention provides a low-current-drain RF transceiver for use in short-range communications, such as wireless headset/phoneset pairs for landline and cellular phones, wireless computer keyboards, and the like. The invention enables clear transmission and reception of radio signals by the transceiver using two small, commonly available, low-voltage batteries, while dramatically extending the transceiver's battery life between recharge events (e.g., 120 hours, versus the current art's typical 3 to 6 hours).

The inventive transceiver circuits incorporate an arrangement that draws an extremely low supply current from two low-voltage batteries while providing clear two-way communication over a range of about 3 meters. The transmitted power is low enough to be permitted under current United States Federal Communications Commission rules without requiring special certifications or licensing.

It is therefore an object of the present invention to provide a new and improved RF low-current-drain transceiver, powered by two commonly available low-voltage batteries, that is useful for clear wireless full-duplex communications over short distances.

Another object or feature of the present invention is to significantly extend the transceiver's operational time before its batteries require recharging.

A further object of the present invention is to provide a novel transceiver circuit arrangement for providing extended operational time on a single battery charge by reusing current from a portion of the transmitter circuitry to power a portion of the receiver circuitry.

Yet another object or feature of the present invention is to provide a novel transceiver circuit arrangement for providing extended operational time on a single battery charge by reusing current from one portion of the receiver circuitry to power another portion of the receiver circuitry.

It is an additional object or feature of the present invention is to provide a novel transceiver circuit arrangement for providing extended operational time on a single battery charge by reusing current from one portion of the power control circuitry to power a portion of the receiver circuitry.

It is even further an object or feature of the present invention is to provide a novel transceiver circuit arrangement for providing extended operational time on a single battery charge by using the internal logic of an interrupt-driven microcontroller to turn power off to as many transceiver circuits as practical for as much time as is practical when insufficient RF signal is received.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and not intended as a definition of the limits of the invention. The various features of novelty that characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

Also, it is to be understood that the terminology and phraseology employed herein are for descriptive purposes only, and not limitation. Where specific dimensional and material specifications have been included or omitted from the specification or the claims, or both, it is to be understood that the same are not to be incorporated into the appended claims.

As such, those skilled in the art will appreciate that the conception, upon which this disclosure is based may readily be used as a basis for designing other structures, methods, and systems for carrying out the several purposes of the present invention. It is important, therefore, that the claims are regarded as including such equivalent constructions as far as they do not depart from the spirit and scope of the present invention. Rather, the fundamental aspects of the invention, along with the various features and structures that characterize the invention, are pointed out with particularity in the claims annexed to and forming a part of this disclosure. For a better understanding of the present invention, its advantages and the specific objects attained by its uses, reference should be made to the accompanying drawings and descriptive matter in which there are illustrated the preferred embodiment.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic view of the power management section of a low-current RF transceiver incorporating the novel circuitry arrangement of this invention;

FIG. 2 is a schematic view of the RF transmitter, RF receiver and battery sections of a low-current RF transceiver incorporating the novel circuitry arrangement of this invention.

FIG. 3 is a schematic view of an alternate embodiment of the power management section of a low-current RF transceiver incorporating the novel circuitry arrangement of this invention; and

FIG. 4 is a schematic view of an alternate embodiment of the RF transmitter, RF receiver and battery sections of a low-current RF transceiver incorporating the novel circuitry arrangement of this invention.

### DETAILED DESCRIPTION OF THE INVENTION

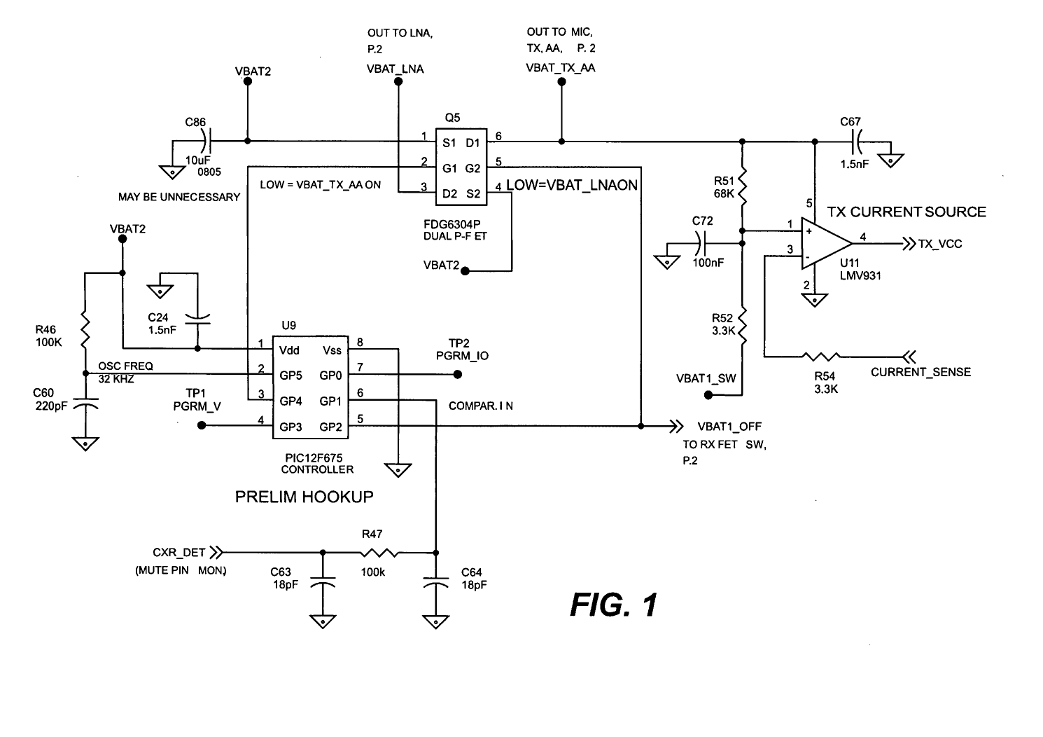

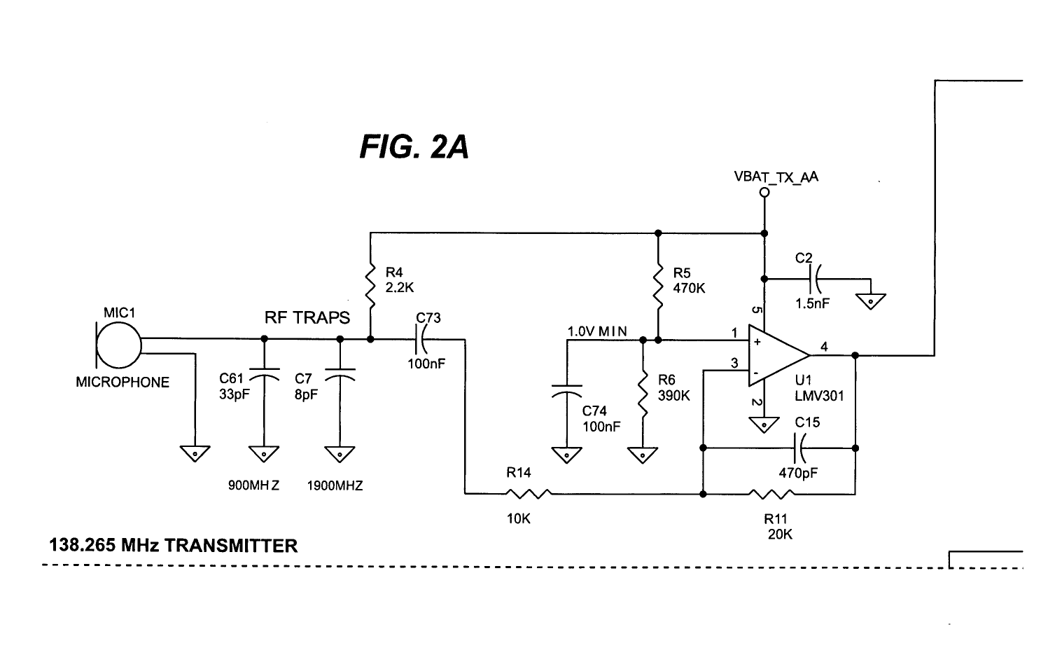

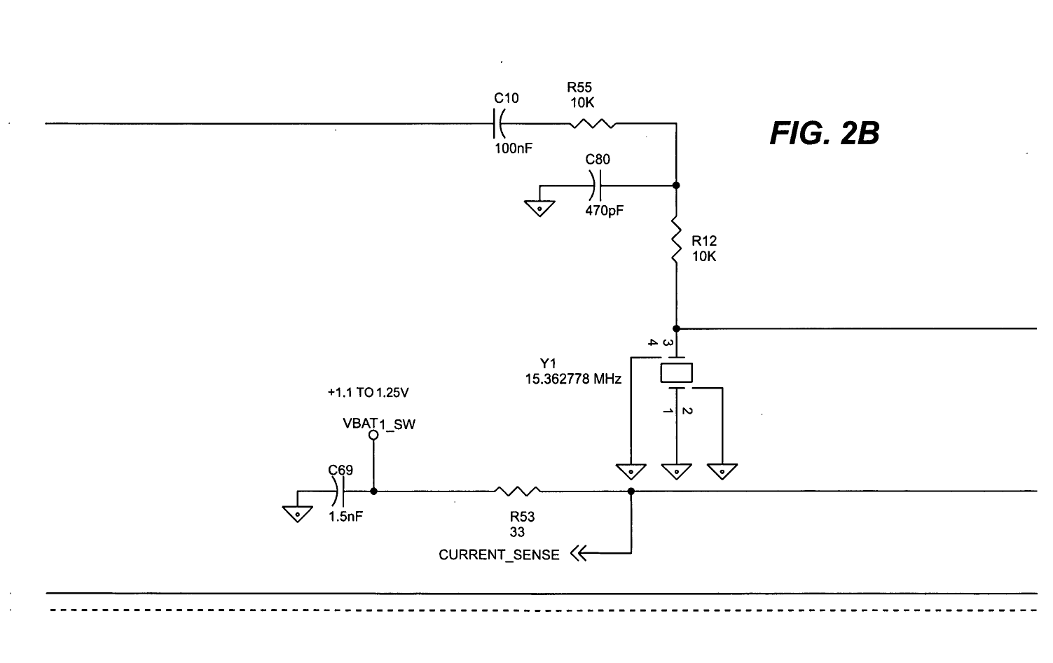

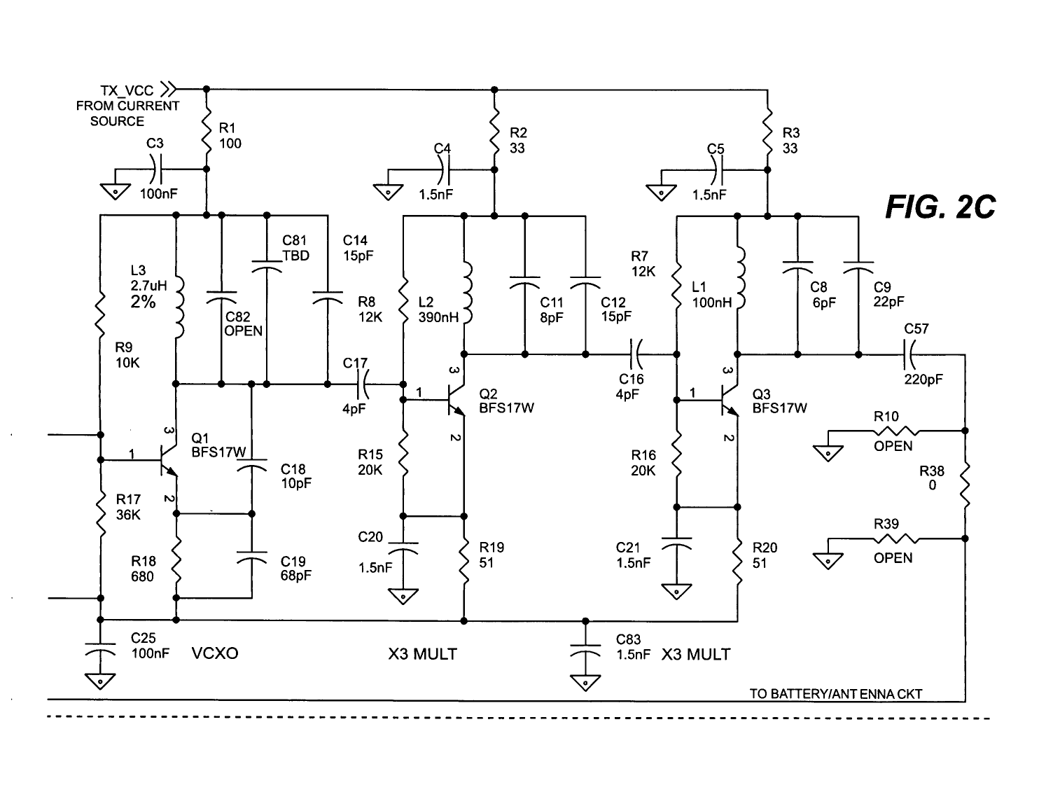

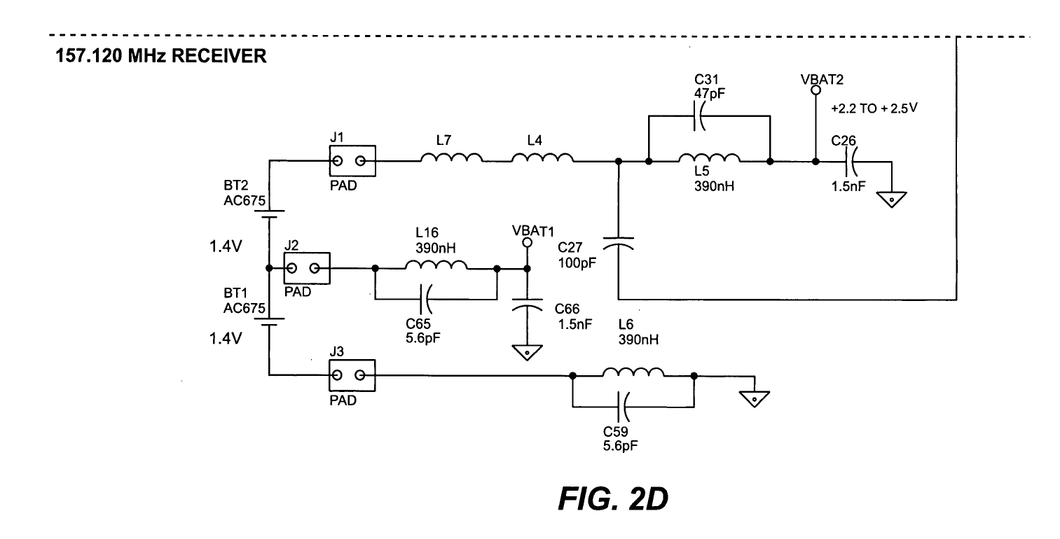

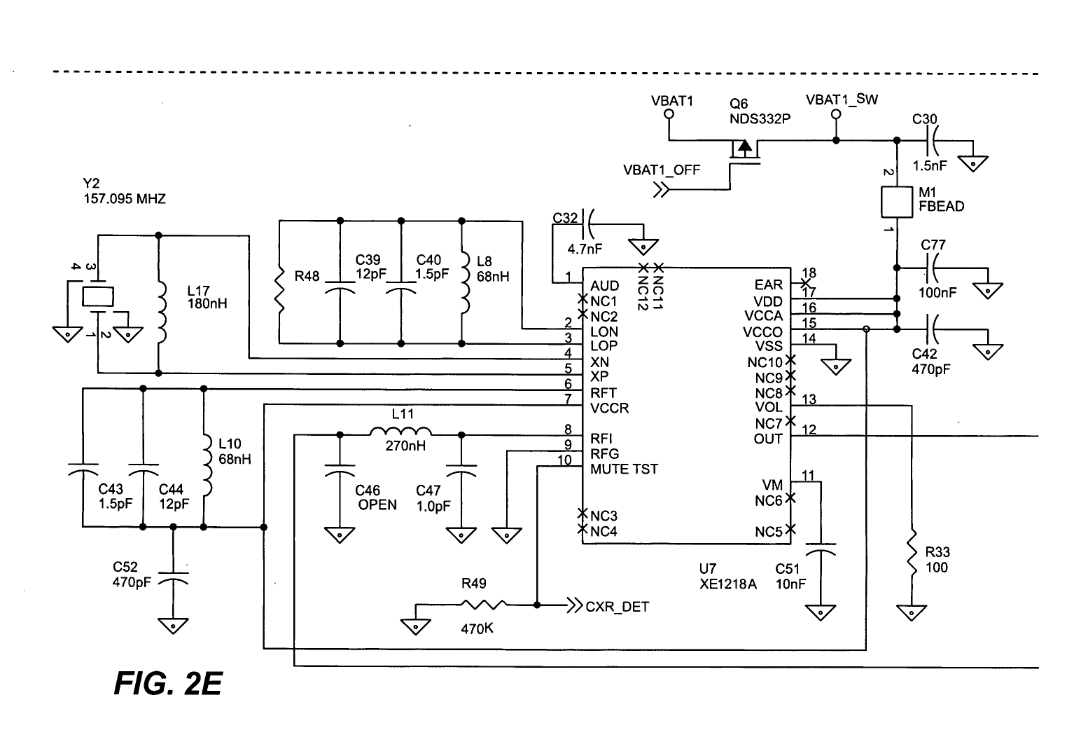

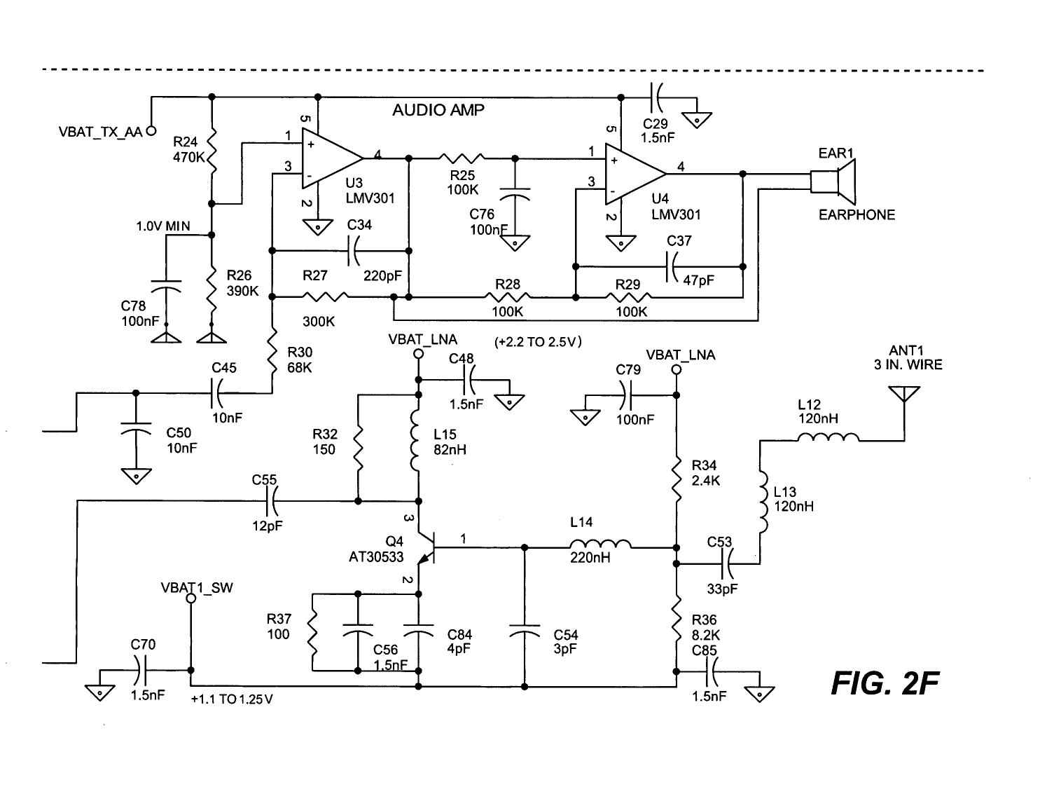

Referring first to FIGS. 1 and 2, wherein like reference numerals refer to like components in the various views, there are illustrated therein, exemplary schematic views of a preferred embodiment of a new and improved low-current RF transceiver. FIG. 1 is a schematic view of the power management section of a low-current RF transceiver incorporating the novel circuitry arrangement of this invention, and FIG. 2 is a schematic view of the RF transmitter, RF receiver and battery sections of the low-current RF transceiver of FIG. 1. Note that FIGS. 1 and 2 should be viewed as separate parts of a single schematic diagram. In each case where an electrical connection point in the schematic drawing is diagrammatically separated from another electrical connection point with which it has an electrical junction, both electrical connection points are labeled identically to indicate their shared electrical junction.

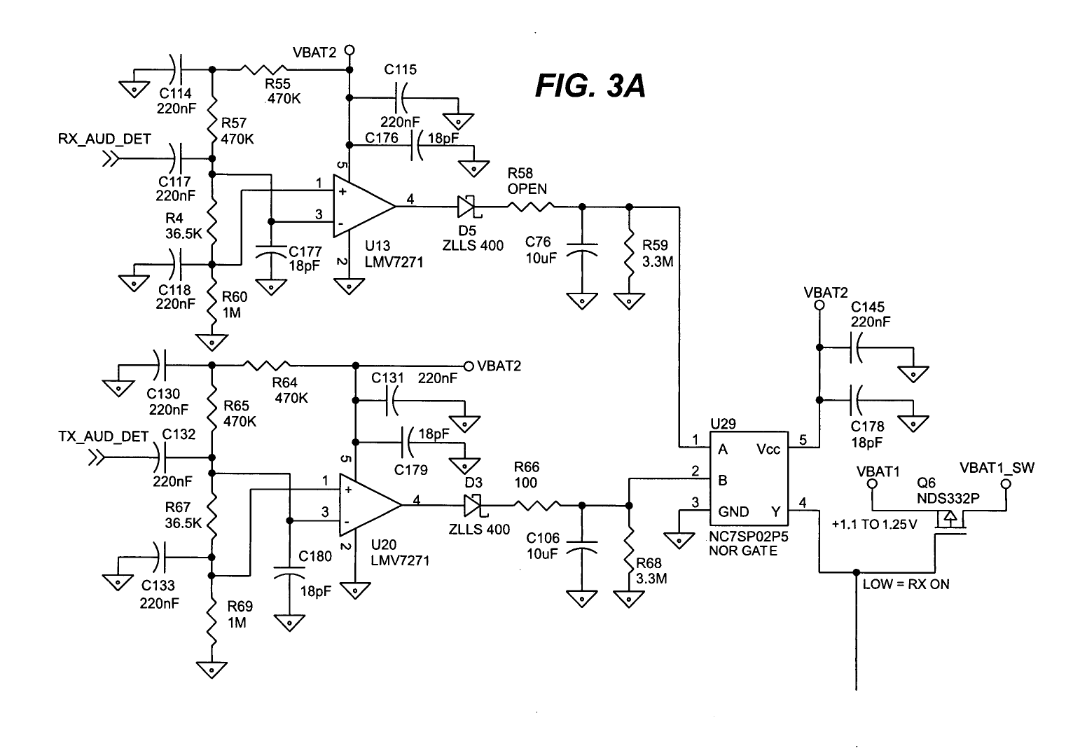

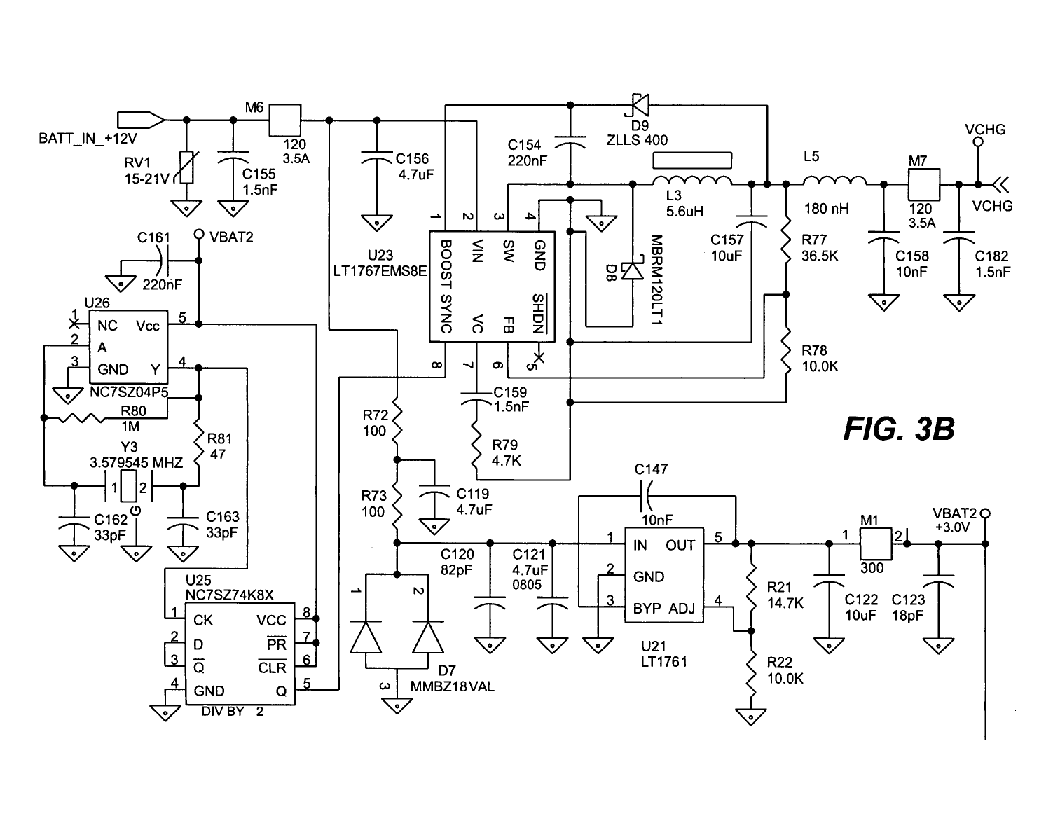

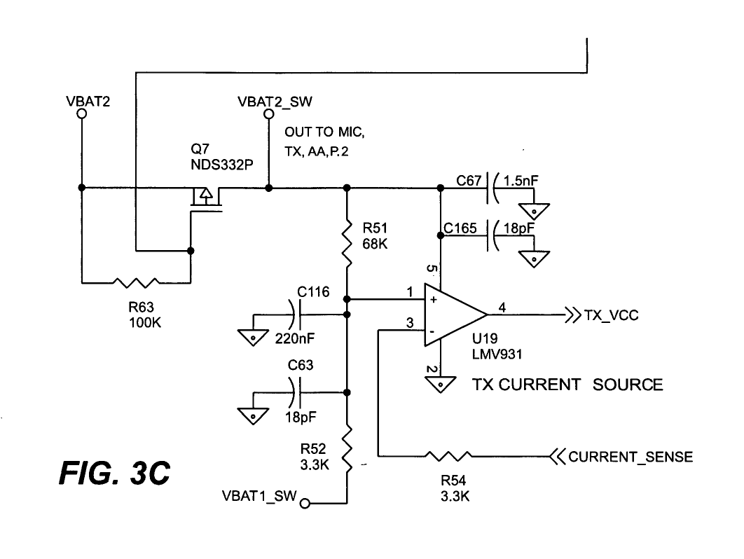

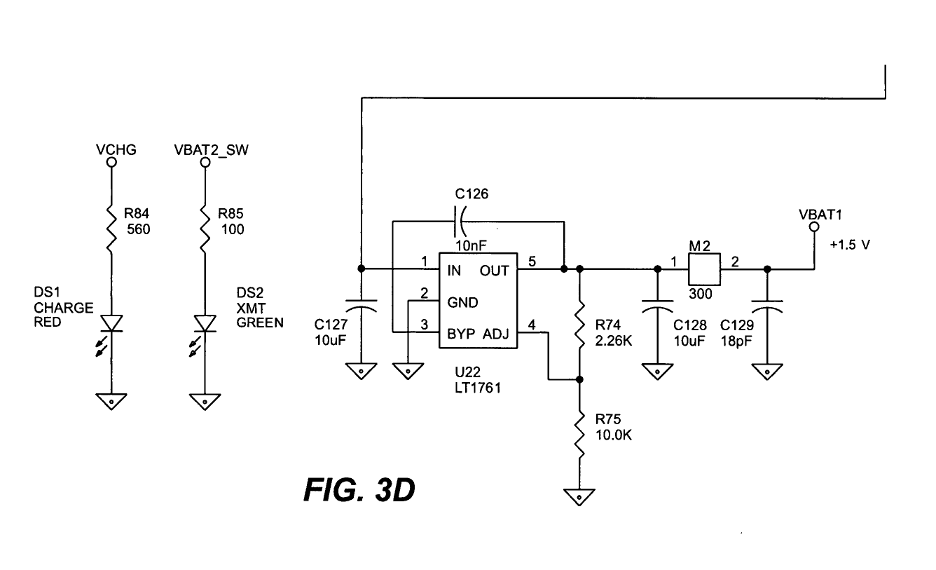

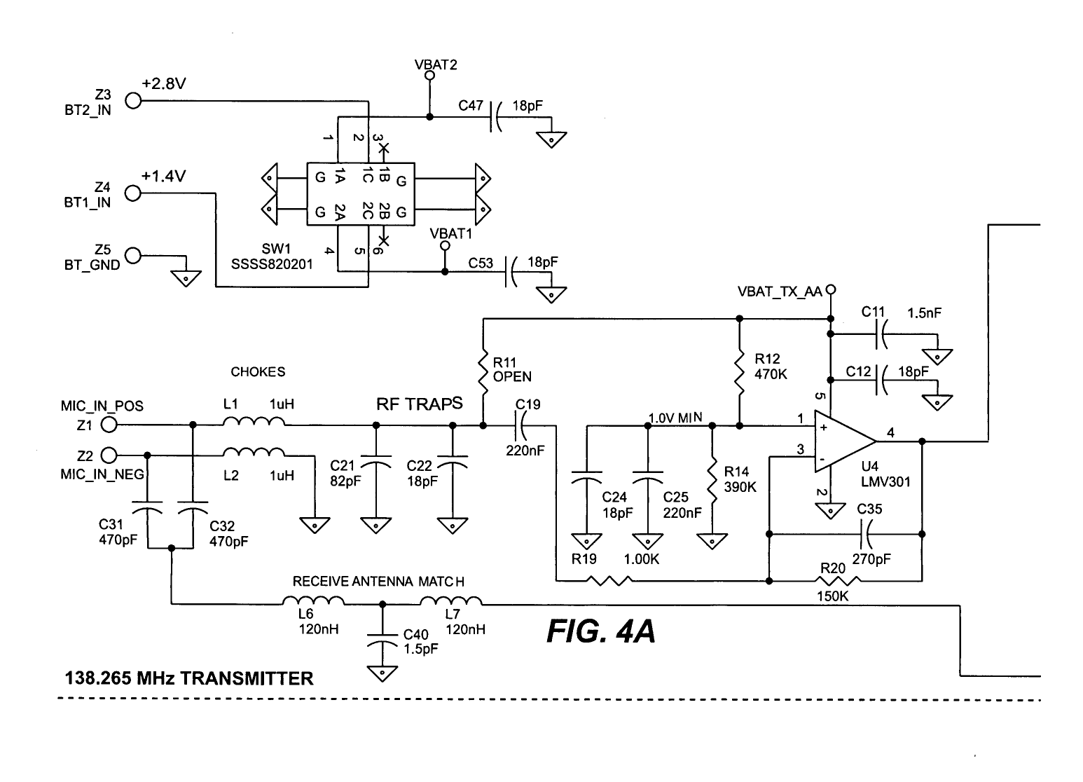

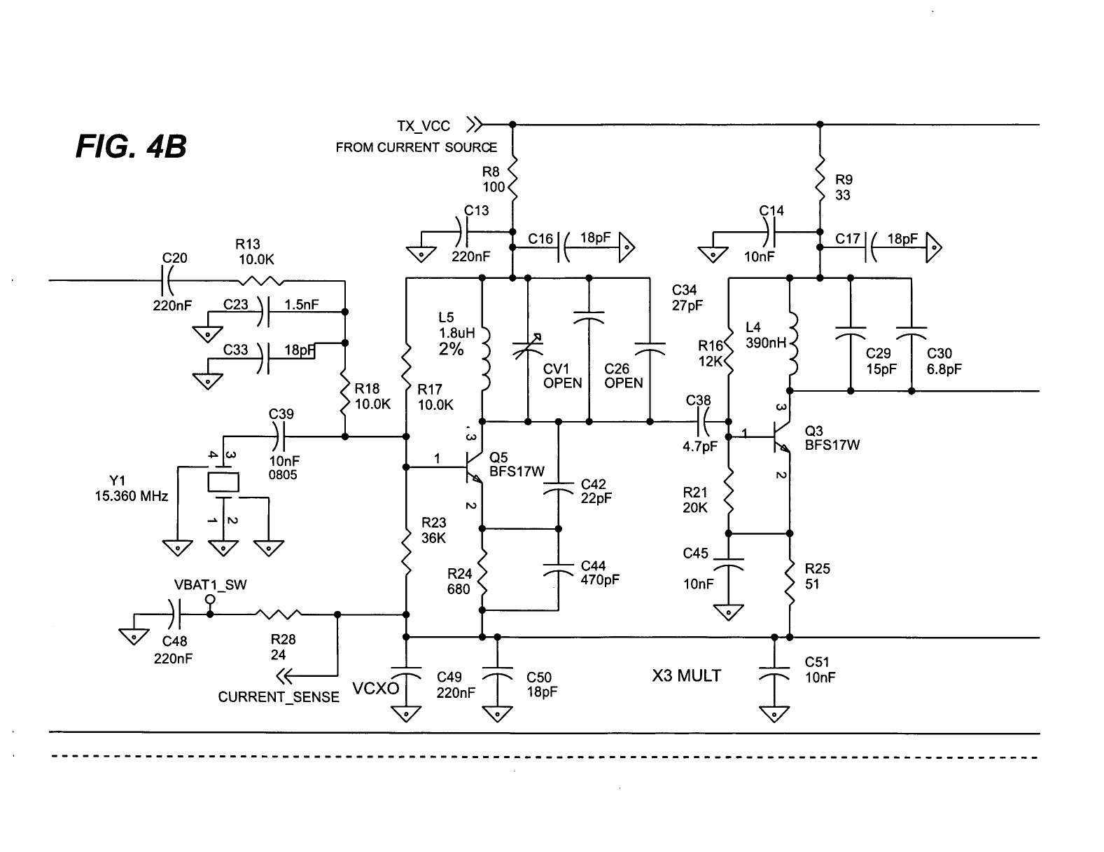

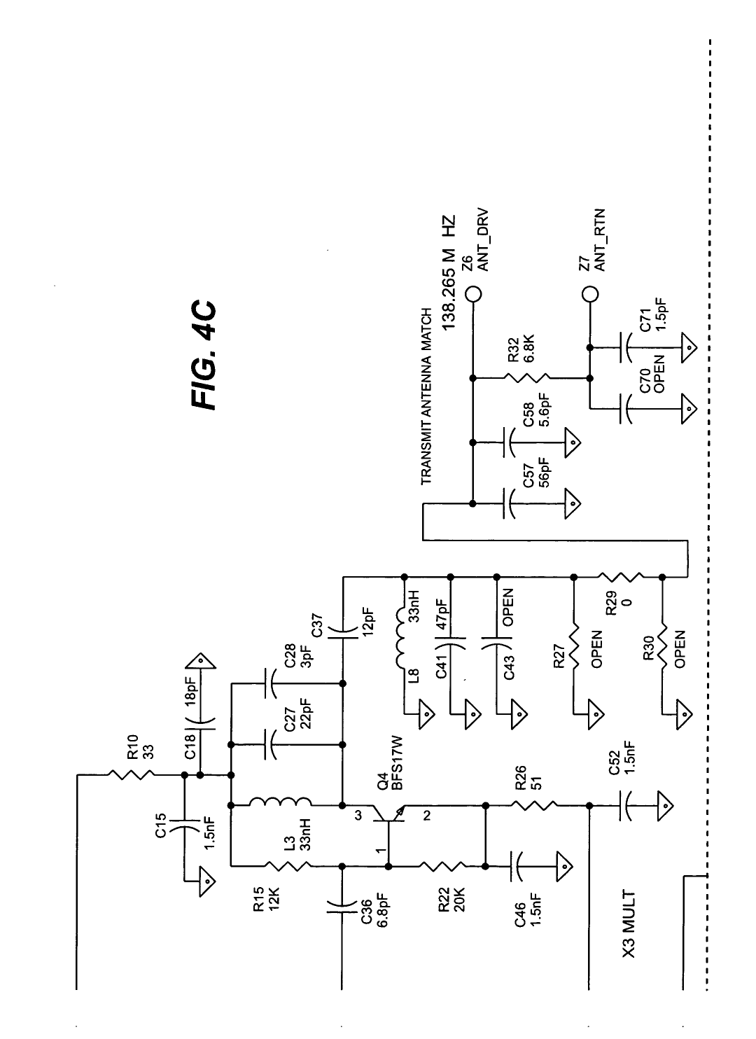

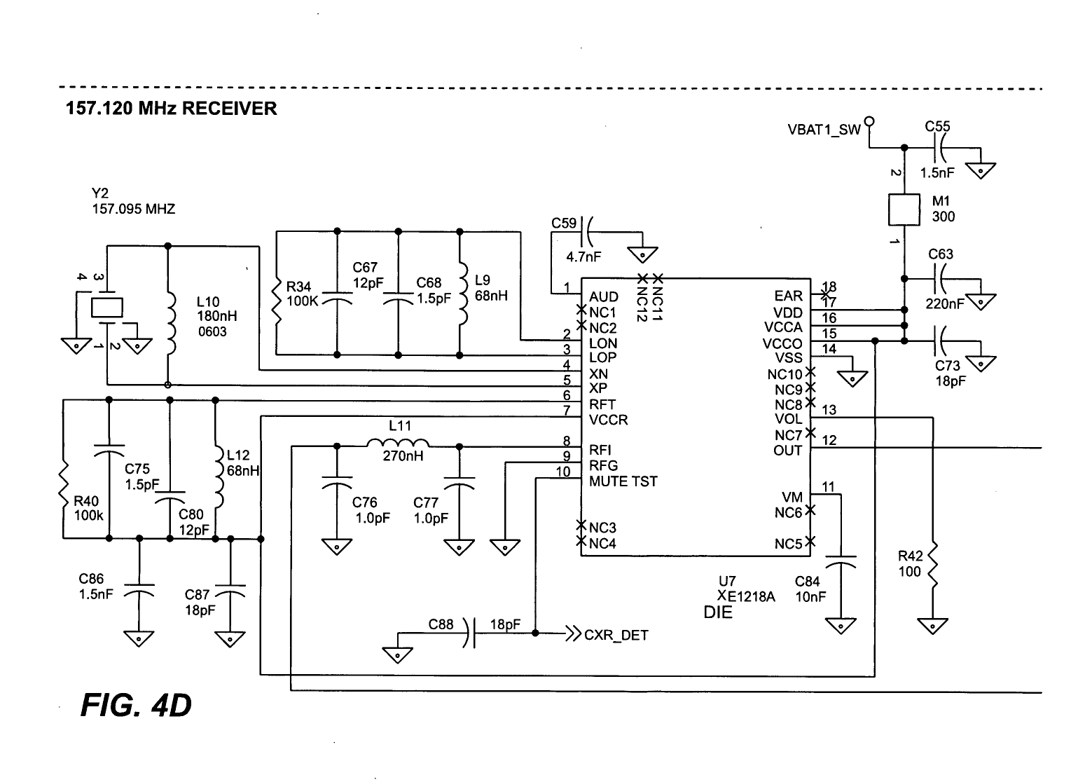

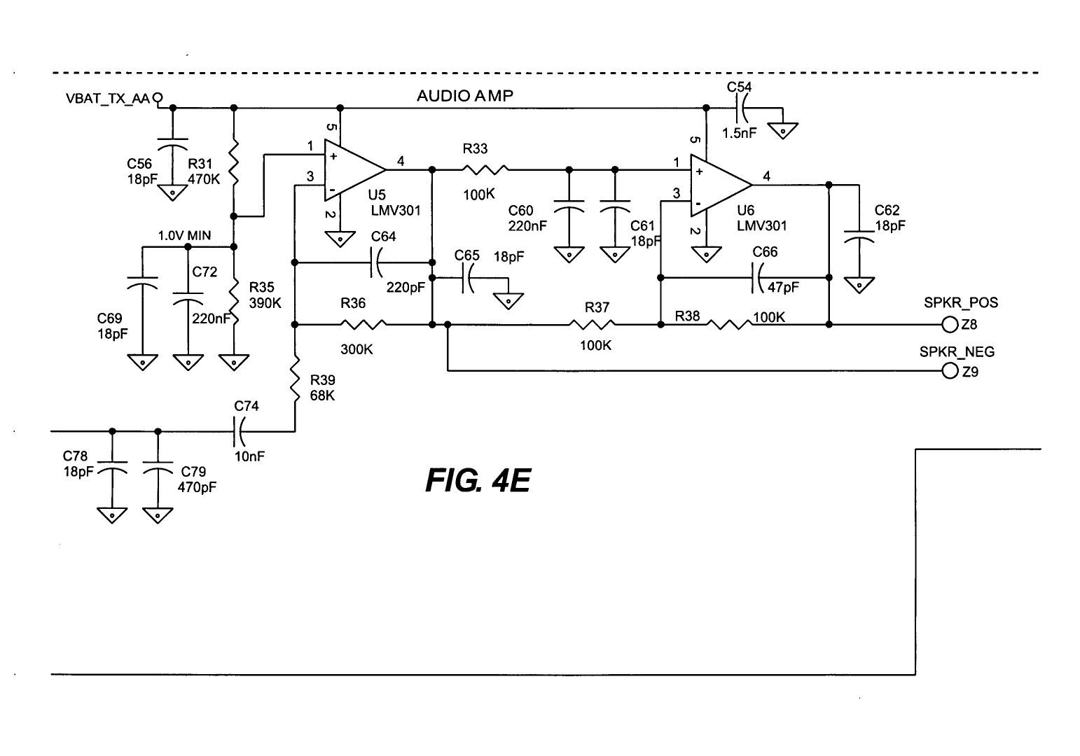

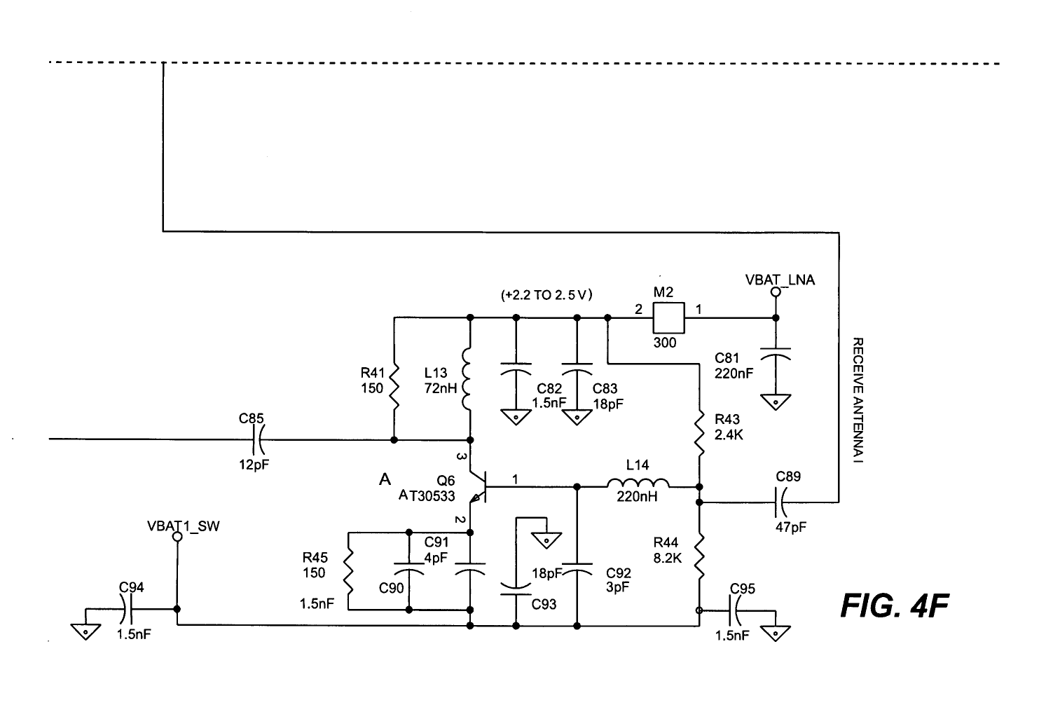

Overview of Inventive Features: While FIG. 1 and FIG. 2 are used to describe these novel features, the transceiver schematic design shown in FIG. 3 and FIG. 4 represents an alternative embodiment of the invention that retains these same advantages, while having reasonable variations in specific component values and arrangements. It is also important to note that, while the schematics show a transceiver that transmits a carrier signal on a specific radio frequency, and receives a carrier signal of a specific frequency, the inventive features of the transceiver are not related to the operating frequencies of the RF circuits.

In preview, the following are some of the unique aspects of the inventive circuit design that, in combination, permit the design to accomplish the aforementioned objectives.

The use of a low-voltage, very-low-current, commercially available FM RF receiver chip reduces battery drain during receiver operation. In FIG. 2, it can be seen that the receiver chip is U7.

The use of two batteries (with a center tap between the two) compensates for supply current variations from unit to unit in the receiver, without affecting the transmitter operation. BT1 and BT2 in FIG. 2 are the batteries used by the transceiver.

The use of a frequency multiplier chain in the transmitter circuit permits very low-current operation and takes advantage of the sufficiently wideband frequency modulation capability of a crystal oscillator. It can be seen that, in FIG. 2, oscillator Q1 is the transmit oscillator; Q2 and Q3 are each X3 multiplier stages.

The use of an operational amplifier-controlled current source provides the ability to stabilize the power output of the transmit frequency multiplier circuits. Operational amplifier U11 (seen in FIG. 1) performs this function.

Directly modulating the transmitter's fundamental frequency oscillator Q1 transistor, without the use of a varactor, avoids the undesirable variations in varactor capacitance from unit to unit, while providing a power-efficient modulation stage. In FIG. 2, Crystal Y1 and oscillator Q1 are frequency-modulated directly by the baseband signal impressed onto the base of oscillator Q1.

By re-using the current from portions of the transmitter, receiver and power control circuits to provide power to low-current-drain receiver chip U7 of the receiver (seen in FIG. 2), the invention reduces battery drain during receiver operation. Referring to FIG. 2, it can be seen that current passing through transmitter components Q1, Q2, and Q3 provides power to receiver chip U7. It can also be seen that current passing through receiver component LNA Q4 provides additional power to receiver chip U7. It can finally be seen that current passing through power control components R51 and R52 (both seen in FIG. 1) provides further power to receiver chip U7. Notably, when receiver chip U7 is drawing less current, the voltage present at connection pint VBAT1_SW is higher, causing the voltage at the center-tap of the voltage divider network comprised of resistor R51 and R52 to be reduced, thereby reducing the output voltage at pin 4 of operational amplifier U11. Pin 4 of operational amplifier U11 acts as a constant current source for all components drawing power from connection point TX_VCC. This has the effect of stabilizing the output power of the transmitter stages when there are changes in the current drawn by receiver chip U7 from connection point VBAT1_SW (seen in FIG. 2).

These inventive features of the transceiver can be seen in combination with the rest of the transceiver circuits as described below.

Theory of transmitter circuit operation: Referring now to FIG. 2, the components of the transmitter section of the transceiver circuitry are seen on the top half of the schematic diagram.

The transmitter of this example, is shown to accept an audio input from a microphone MIC1, but could easily be slightly modified by a person reasonably skilled in the art to accept a baseband input from another circuit that produces audio signals (including data modulated into an audio form, such as with a modem).

The transmitter circuit has five main sections. These include the audio section (comprised of MIC1 and preamp U1, along with their supporting components), oscillator Q1 and its associated components, X3 multiplier Q2 and its associated components, X3 multiplier Q3 and its associated components, and the transmit antenna section that includes the tuning components surrounding the batteries BT1 and BT2 (the batteries, in this example, are part of the antenna circuit).

TX Audio Section: The output of microphone MIC1 is coupled to the input (pin 3) of preamp U1 via DC blocking capacitor C73 and resistor R14. Filter capacitors C1 and C61 prevent stray RF signals from being impressed upon the input of preamp U1. Filter capacitors C2 and C74 prevent any signals generated by preamp U1 from being coupled to the power source present at connection point VBAT_TX_AA. The voltage divider network comprised of resistors R5 and R6 set the operational bias for preamp U1. Resistor R11 sets the gain characteristics of preamp U1. Capacitor C15 prevents high-frequency oscillations from being generated by preamp U1. Audio signals amplified by preamp U1 are coupled to the base of oscillator Q1 via DC blocking capacitor C10, resistor R55 and R12. Capacitor C80 provides an RF path to ground, preventing RF signals at the base of oscillator Q1 from leaking into the preamplifier circuitry.

TX VCXO: The transmitter uses a voltage-controlled crystal oscillator Q1, which also acts as the transmitter modulator when an audio signal is impressed upon its base. Pin 3 of crystal Y1 is directly connected to the base of oscillator Q1, causing oscillator Q1 to oscillate at a very stable frequency that is frequency-modulated by audio when it is also present at the base of oscillator Q1. The voltage divider network formed by resistors R9 and R17 provide the proper DC biasing voltage to the base of oscillator Q1. Resistor R18 provides a path for DC current to flow through the emitter of oscillator Q1. Inductor L3 provides a path for DC current to flow through the collector of oscillator Q1. Inductor L3 additionally forms part of the oscillator Q1 tuning circuit that also includes capacitors C14, C18, C19, C81 and C82. The filter network formed by resistor R1 and capacitor C3 prevent the RF energy generated by oscillator Q1 from leaking into the power source. Capacitor C25 provides an RF path to ground for oscillator Q1. The output of oscillator Q1 is coupled to the input of X3 multiplier Q2 via DC isolation capacitor C17.

First X3 Multiplier: The first X3 multiplier Q2 triples the frequency of the RF signal received at its input (base). The voltage divider network formed by resistors R8 and R15 provide the proper DC biasing voltage to the base of X3 multiplier Q2. Resistor R19 provides a path for DC current to flow through the emitter of X3 multiplier Q2. Inductor L2 provides a path for DC current to flow through the collector of X3 multiplier Q2. Inductor L2 additionally forms part of the X3 multiplier Q2 output tuning circuit that also includes capacitors C11 and C12. The filter network formed by resistor R2 and capacitor C4 prevent the RF energy generated by X3 multiplier Q2 from leaking into the power source. Capacitor C83 provides an RF path to ground for X3 multiplier Q2. The RF output from the first X3 multiplier Q2 is coupled to the input of the second X3 multiplier Q3 via DC blocking capacitor C16.

Second X3 Multiplier: The second X3 multiplier Q3 triples the frequency of the RF signal received at its input (base). The voltage divider network formed by resistors R7 and R16 provide the proper DC biasing voltage to the base of X3 multiplier Q3. Resistor R20 provides a path for DC current to flow through the emitter of X3 multiplier Q3. Inductor L1 provides a path for DC current to flow through the collector of X3 multiplier Q3. Inductor L1 additionally forms part of the X3 multiplier Q3 output tuning circuit that also includes capacitors C8 and C9. The filter network formed by resistor R3 and capacitor C5 prevent the RF energy generated by X3 multiplier Q3 from leaking into the power source. Capacitor C83 provides an RF path to ground for X3 multiplier Q3. The RF output from the second X3 multiplier Q3 is coupled to the transmit antenna circuit via DC blocking capacitor C57.

Transmit Antenna: The transmit antenna circuit, in this example, is comprised of the resistor network containing resistors R0, R38 and R39, coupling capacitor C27, inductors L4, L5, L6, L7, and capacitors C31, C59 and C65. With this circuit arrangement, the batteries BT1 and BT2 also become part of the tuned transmit antenna circuit.

Theory of Receiver Circuit Operation: Referring again to FIG. 2, the components of the receiver section of the transceiver circuitry are seen on the bottom half of the schematic diagram.

The receiver is shown, in this example, to produce an audio output that drives an earphone EAR1, but could easily be slightly modified by a person reasonably skilled in the art to produce a baseband output that can drive another circuit that accepts audio signals (including data modulated into an audio form, such as with a modem).

The receiver circuit has four main sections. These include receive antenna ANT1 and its associated components, which feed low-noise RF amplifier (LNA) Q4 and its associated components, which in turn feed receiver chip U7 and its associated components, which demodulate the baseband signal to produce audio that is fed to the audio amplification section that includes baseband amplifiers U3 and U4 along with their associated components.

Receive Antenna: In operation, antenna ANT1 passes RF signals impressed onto its elements through inductors L12 and L13, capacitor C53 and inductor L14 onto the base of LNA Q4.

Low-noise Amplifier (Lna): LNA Q4 has the following supporting components:

Capacitors C48, C70, C79 and C85 are used to filter to ground any RF signals that would otherwise be modulated onto the DC power source. R34 and R36 form a voltage divider network that uses current available from connection point VBAT_LNA to set the bias on the base of LNA Q4. Inductor L14 and capacitor C54 compose the input tuning elements of LNA Q4. Inductor L15, capacitor C58 and capacitor C84, in combination, compose the output tuning elements of LNA Q4. Resistor R32 and R37 provide the appropriate DC biasing voltages to LNA Q4 when it is in a quiescent state.

When operational, LNA Q4 amplifies the received RF signal, and couples the amplified signal to the RF input (pin 8) of receiver chip U7 via DC isolation capacitor C55 and inductor L11. Note that inductor L11, capacitor C46 and capacitor C47, in combination, form an RF band filter to eliminate out-of-band signals that have been amplified by LNA Q4.

Receiver Chip: Receiver chip U7 is a very-low-current ‘receiver-on-a-chip’ component that contains the well-known circuits commonly used in RF receivers. Receiver chip U7 has the following external supporting components:

Capacitor C32 is connected directly between circuit ground and pin 1 of receiver chip U7, providing tuning of chip-internal de-emphasis for the received audio. Resistor R48, capacitors C39 and C40 and inductor L8 are connected across pins 2 and 3 of receiver chip U7, determining the operating frequency of the internal local oscillator of receiver chip U7. Crystal Y2 and inductor L17 are connected across pins 4 and 5 of receiver chip U7, providing tuning to the chip-internal RF oscillator of receiver chip U7. Capacitors C43, C52 and C44 and inductor L10 are connected across pins 8 and 9 of receiver chip U7, providing tuning elements to the chip-internal receiver's front-end stages. Capacitors C46 and C47 and inductor L11 form an input filter network, connecting the output of LNA Q4 to the RF signal input pin 8 of receiver chip U7. Resistor R49 is connected between ground and pin 10 of receiver chip U7, providing a pull-down condition to the chip-internal comparator of receiver chip U7. Capacitor C51 is connected between ground and pin 11 of receiver chip U7, providing a filter for receiver chip U7. Resistor R33 is connected between ground and pin 13 of receiver chip U7, setting the output audio volume of receiver chip U7. Capacitors C30, C42 and C77, along with ferrite bead M1, provide filtration of RF energy from the DC source for receiver chip U7. The audio signal output of receiver chip U7 is coupled from pin 12 across capacitor C56, and through DC blocking capacitor C45 and resistor R30 to the input pin 3 of baseband amplifier U3.

Audio Amplifier Section: The audio amplifier section of the receiver is comprised of baseband amplifiers U3 and U4 along with their associated components.

Baseband amplifiers U3 and U4 are arranged as a differential pair, having the following associated components:

Audio received at the input (pin 3) of baseband amplifier U3 is amplified and coupled from its own output pin 4, directly to the bottom input pin of earphone EAR1, as well as through resistor R25, across RF filter capacitor C76, to the input (pin 1) of the second baseband amplifier U4. Filter capacitor C78 prevents stray RF signals from being impressed upon the input of baseband amplifier U3. Filter capacitor C29 prevents any signals generated by baseband amplifiers U3 or U4 from being coupled to the power source present at connection point VBAT_TX_AA. The voltage divider network comprised of resistors R24 and R26 set the operational bias for baseband amplifier U3. Resistor R27 sets the gain characteristics of baseband amplifier U3. Capacitor C34 prevents high-frequency oscillations from being generated by baseband amplifier U3. Audio received at the input (pin 1) of baseband amplifier U4 is amplified and coupled from its own output pin 4, directly to the top input pin of earphone EAR1. Filter capacitor C76 prevents stray RF signals from being impressed upon the input of baseband amplifier U4. The value of resistor R28 sets the operational bias for baseband amplifier U4. Resistor R29 sets the gain characteristics of baseband amplifier U4. Capacitor C37 prevents high-frequency oscillations from being generated by baseband amplifier U4.

Theory of Power Management Circuit Operation: Referring once again to FIG. 2, the batteries BT1 and BT2, and their associated components, are seen on the left-hand side of the schematic diagram at about the vertical midpoint of the diagram. Switch Q6 is seen in FIG. 2 directly above receiver chip U7.

Still referring to FIG. 2, the following electrical connection points are labeled: VBAT1, VBAT2, VBAT_TX_AA, VBAT_SW, TX_VCC, CURRENT_SENSE, VBAT_LNA, CXR_DET, and VBAT1_OFF. Each of these electrical connection points has at least one mating, identically-labeled, electrical connection point in the schematic section shown in FIG. 1.

Now referring back to FIG. 1, microcontroller U9 is seen on the bottom-center of the schematic diagram. Dual P-channel digital field-effect transistor (FET) Q5 is seen at the top center of the schematic diagram. Operational amplifier U11 is seen on the top, right-hand side of the schematic diagram. These components are used to control the availability of current to various portions of the transceiver from each of the available sources.

Referring once again to FIG. 2, it can be seen that battery BT1 and battery BT2 provide a center-tapped power source for the transceiver's transmit and receive circuits. The negative side of battery BT1 is the DC power ground for the transceiver circuits. The positive side of battery BT1 (connected directly to the negative side of battery BT2) provides, via inductor L16, a positive 1.4 volts current source (VBAT1) to the emitter of switch Q6. The positive side of battery BT2 provides, via inductors L7, L4 and L5, a positive 2.8 volts current source (via connection point VBAT2) to pin 1 of FET Q5, pin 4 of FET Q5 and pin 1 of microcontroller U9 (all seen in FIG. 1).

Operational amplifier U11 (seen in FIG. 1), using feedback from R53 (seen in FIG. 2) via the CURRENT_SENSE signal and resistor R54 (seen in FIG. 1), provides a constant supply current via connection point TX_VCC to the transmitter circuit. Filter capacitor C72 prevents stray RF signals from being impressed onto the input pin 1 of operational amplifier U11. Filter capacitor C67 drains to circuit ground any RF energy present at DC power input pin 5 of operational amplifier U11.

Control of the each of the various current sources used by the transceiver is handled by microcontroller U9 through the connections and components described below. Later in this disclosure, the simple logic programmed into microcontroller U9 is described in detail under the heading of “Microcontroller Logic.”

When pin 5 of microcontroller U9 is set to a logical low output condition, pin 5 of FET Q5 is driven simultaneously to a logical low input condition.

During the times that pin 5 of FET Q5 is pulled to a logical low input condition, an internal short circuit is created between pins 3 and 4 of FET Q5. This allows current to flow from current source VBAT2 to all connection points in common with connection point VBAT_LNA. This is the source of current used to power the low-noise amplifier (LNA) Q4 of the receiver circuit shown in FIG. 2). The current that flows through the LNA Q4 circuit is drained into connection point VBAT1_SW, thus providing an additional current source to any components that use VBAT1_SW as a source of power input.

Alternately, when pin 5 of microcontroller U9 is raised to a logical high output condition, pin 5 of FET Q5 is driven simultaneously to a logical high input condition.

During the times that pin 5 of FET Q5 is pulled to a logical high input condition, an internal open circuit is created between pins 3 and 4 of FET Q5. This prevents current from flowing from current source VBAT2 to any connection points in common with connection point VBAT_LNA. This is the source of current used to power the low-noise amplifier (LNA) Q4 of the receiver circuit shown in FIG. 2).

Referring back to FIG. 2, receiver chip U7, whose VSS (ground) is on pin 14, and whose input power is on pins 15 through 17, has two sources of input power.

Current for receiver chip U7 is available via resistor R53, the VBAT1_SW connection point and ferrite bead M1 during the times that any or all of oscillator Q1, X3 multiplier Q2 and X3 multiplier Q3 are conducting current between their collector and emitter.

Current for receiver chip U7 is also available from connection point VBAT1, via switch Q6, when switch Q6 is turned on (allowing current to flow between its emitter and collector) by presence of a logical low signal on its base. The collector of switch Q6 provides VBAT1-sourced current to connection point VBAT1_SW (and therefore to receiver chip U7 via ferrite bead M1).

Microcontroller Logic: Now referring to FIG. 1, microcontroller U9 is programmable by placing a ‘programming voltage’ on its own pin 4 (via connection point TP1), while providing binary program data serially into its own pin 7 via connection point TP2. Microcontroller U9 is programmed with simple well-known internal logic functions that perform the following operations:

First, microcontroller U9 is in sleep mode (internal oscillator running, internal system clock stopped) most of the time. The internal logic of microcontroller U9 assumes an initial condition of the logical CXR_DET signal input (on its own pin 6) to be at a logical low. The CXR_DET signal is generated by receiver chip U7 (on its own pin 10, as seen in FIG. 2) when sufficient RF signal is being received to allow clear communications.

Second, every 17 milliseconds, microcontroller U9 “wakes up” upon receipt of an interrupt signal generated by an internal watchdog timer. Microcontroller U9 counts 30 of these interrupt signals before it initiates a detection cycle, thus minimizing the amount of time that the internal comparator of microcontroller U9 and the RF receiver circuit are turned on (drawing current from the batteries). This results in the processing of a single detection cycle every 510 ms.

Third, upon receipt of the first interrupt of a detection cycle, microcontroller U9 turns on its internal comparator, and then drives its own pin 5 to a logical low level, which causes power to be connected to receiver chip U7 and LNA Q4 (both seen in FIG. 2). Then microcontroller U9 sleeps until it receives the next interrupt from its internal watchdog timer.

Fourth, upon receipt of the second interrupt of a detection cycle, microcontroller U9 goes back to sleep to give the receiver chip U7 another 17 ms to power-up and establish reception of sufficient RF carrier signal, if any is present.

Fifth, upon receipt of the third interrupt of a detection cycle, microcontroller U9 checks its internal comparator to determine the logical signal level present on its own pin 6. The input on pin 6 is a logical CXR_DET signal received from receiver chip U7 (seen in FIG. 2). If sufficient RF carrier signal is not detected by receiver chip U7, receiver chip U7 outputs a logical high as the CXR_DET signal. When sufficient RF carrier signal is detected by receiver chip U7, receiver chip U7 outputs a logical low as the CXR_DET signal.

Sixth, if a logical low is detected on pin 6 of microcontroller U9 (sufficient RF carrier signal is detected), microcontroller U9 drives its own pin 3 to a logical low level, thus connecting power to the transceiver's transmitter circuitry by pulling pin 2 of FET Q5 low, which causes FET Q5 to create an internal short circuit between its own pins 4 and 6. This allows current available at connection point VBAT2 to be delivered to all points connected to connection points VBAT_TX_AA (audio circuits) and TX_VCC (transmitter circuits). Then microcontroller U9 goes back to sleep with both the transmitter and receiver circuitry powered on. Microcontroller U9 wakes up and checks its own pin 6 condition upon reception of each subsequent interrupt signal from its internal watchdog timer. If the condition is still a logical low (sufficient received RF carrier is still present), microcontroller U9 goes back to sleep until the next received interrupt signal.

Seventh, if, in the third interrupt of the detection cycle (or one of those subsequent interrupts when the condition of its own pin 6 is checked), microcontroller U9 finds its own pin 6 condition at a logical high (there is not sufficient received RF carrier signal), microcontroller U9 drives both of its own pins 5 and 3 to a logical high level, thus disconnecting power from the receiver and transmitter circuits. Microcontroller U9 then internally turns off power to its internal comparator, goes to sleep, and returns to step 2 above (restarts the whole cycle).

Microcontroller Power Savings Strategies: Microcontroller U9 uses an internal R/C oscillator that operates at 4 MHz, and has a 1-microsecond instruction time. Microcontroller U9 executes about 10 instructions in a 50 ms wait cycle, and about 15-17 instructions in any of its other active modes. This means that microcontroller U9 is only awake for a maximum of 17 microseconds out of every 17 ms, or a 1:1000 cycle. This makes the power conservation of an already low-power microcontroller several orders of magnitude better.

Regarding the 500 ms carrier-detect cycle strategy: If no received RF carrier signal is detected by receiver chip U7 (seen in FIG. 2), microcontroller U9 turns on its internal comparator, along with receiver chip U7 and LNA Q4 for only 34 ms out of 500 ms, a duty cycle of 1:15. In this manner, the actions of microcontroller U9 decrease the net current consumption of the receiver to 1/15 of that which would be drawn if those same receiver circuits were turned on continuously.

Thus, the inventive features and advantages are incorporated into the preferred embodiment of the transceiver represented by the schematic drawings of FIG. 1 and FIG. 2.

Alternative Preferred Embodiments of the Invention: To those reasonably skilled in the art, it can be seen that the alternative embodiment of the inventive transceiver (represented by the schematic drawing shown in FIG. 3 and FIG. 4) incorporates the novel features and advantages claimed in the present invention. It can also be seen that, while some specific component values of the alternate embodiment vary from those shown in the preferred embodiment (seen in FIG. 1 and FIG. 2), these value changes do not impact the inventive features incorporated into the transceiver design.

Now referring to FIG. 3, the power control section of an alternate embodiment of the inventive transceiver is schematically represented. In this embodiment, microcontroller U2 operates to control the various current sources available to the transmitter and receiver circuits of the transceiver in the same manner as does the preferred embodiment. Adjunct microcontroller U3 works in concert with microcontroller U2. FET Q1 is controlled by microcontroller U2 to turn on and off the current sources that are used by the transmitter and receiver circuits of the transceiver. This is accomplished in the same manner that is described above in the detailed description of the preferred embodiment of the invention. In the preferred embodiment (seen in FIG. 1), microcontroller U9 is the functional equivalent of microcontroller U2 of the alternate embodiment, and FET Q5 is the functional equivalent of FET Q1 of the alternate embodiment.

Now referring again to FIG. 3, operational amplifier U1 is used to provide a constant current source to the transmitter circuits of the transceiver in the same way the U11 of the preferred embodiment (seen in FIG. 1) performs this function.

In the alternate embodiment of the power control section shown in FIG. 3, switch Q2 is the functional equivalent to switch Q6 of the preferred embodiment (seen in FIG. 2). Switch Q2, under the direct control of microcontroller U2, is used to control the current available to receiver chip U7 from connection point VBAT1.

Now referring to FIG. 4, a schematic view of an alternate embodiment of the transmitter, receiver and battery circuits of the inventive transceiver is seen. In the alternate embodiment, receiver chip U7 operates exactly as detailed in the description of the preferred embodiment (the preferred embodiment's receiver chip is seen in FIG. 2 as U7).

Still referring to FIG. 4, the alternate embodiment of the inventive transceiver has essentially the same transmitter circuit blocks and receiver circuit blocks as does the transceiver of the preferred embodiment of the invention.

These circuit blocks include, in the transmitter section, an external microphone, or other audio source, connected to an audio preamplifier U4, (via connection points Z1 and Z2). Preamplifier U4 impresses baseband onto the base of voltage controlled crystal oscillator (VXCO) Q5, thus modulating the audio onto the RF signal generated by VXCO Q5. First X3 multiplier Q3 and second X3 multiplier Q4 raise the modulated RF carrier signal to the operating frequency of the transmitter. In the alternate embodiment of the inventive transceiver, the transmit antenna circuit does not utilize the batteries (as does the preferred embodiment). The batteries, in the alternate embodiment, are connected through connection points Z3, Z4 and Z5 to mechanical switch SW1. Mechanical switch SW1 is used to turn disconnect the externally connected batteries from connection points VBAT1 and VBAT2.

These circuit blocks also include, in the receiver section, a receive antenna (using the microphone cable as part of the antenna) connected to the input of a low noise amplifier Q6, which feeds received RF signals to receiver chip U7. Receiver chip U7 down-converts and demodulates the received RF signal and passes the baseband signal to baseband amplifiers U5 and U6, which operate as a differential pair to drive a speaker or headphone (via connection points Z8 and Z9).

Still referring to FIG. 4, it is notable that receiver chip U7, of the alternate embodiment of the inventive transceiver, has the same current sources available as are described in the detail of the preferred embodiment. Thus receiver chip U7 of the alternate embodiment reuses current from the transmitter circuits, as well as from LNA Q6 and the bias resistors R1 and R6 (seen in FIG. 3). Additionally, the logic used by microcontroller U9 (of the preferred embodiment of the inventive transceiver seen in FIG. 1) to control the current sources available to the rest of the transceiver (and to conserve on its own power usage), is the same logic used to by microcontroller U2 of the alternate embodiment (seen in FIG. 3).

It can therefore be understood that the alternate embodiment of the invention (shown in FIG. 3 and FIG. 4), while having different component values and arrangements than those of the preferred embodiment (seen in FIG. 1 and FIG. 2), the resulting conservation of power is essentially accomplished in the same manner, with essentially the same results.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A radio-frequency transceiver having a receiver circuit and a transmitter circuit, comprising:
two batteries in series providing a primary current source to the transmitter circuits of said transceiver;
a center-tap disposed between said two batteries for providing a lower-voltage current source to at least one power-consuming element of the receiver circuits;
wherein the transmitter circuit is arranged such that current draining from the transmitter circuit acts as a current source for said at least one power-consuming element of the receiver circuit, and having a power control circuit with a lowered-current-consumption sleep mode and a normal-current-consumption operational mode.

2. The transceiver of claim 1, further including an internal timer that regularly makes available to said power control circuit a timer signal.

3. The transceiver of claim 2, wherein said internal timer regularly withholds said timer signal to said power control circuit at least some fraction of time before making said timer signal available to said power control circuit.

4. The transceiver of claim 2, wherein said power control circuit, when in said lowered-current-consumption operational sleep mode, and upon detection of the presence of said timer signal, switches from said lowered-current-consumption sleep mode into said normal-current-consumption operational mode.

5. The transceiver of claim 2, further including a transmit DC current source and a receive DC current source, and wherein said power control circuit controls the connection of said transmit DC current source to the transmitter circuit and the connection of said receive DC current source to the receiver circuit.

6. The transceiver of claim 5, wherein when said transceiver is in said normal-current-consumption operational mode, said power control circuit receives from said receiver circuit a RF carrier-present signal indicating the presence or absence of received RF signal by said receiver circuit.

7. The transceiver of claim 6, wherein said power control circuit disconnects said transmit DC current source from the transmitter circuit whenever it detects that said RF carrier-present signal indicates the absence of a received RF signal by the receiver circuit.

8. The transceiver of claim 6, wherein said power control circuit connects said transmit DC current source to the transmitter circuit whenever it is detected that said RF carrier-present signal indicates the presence of received RF signal by said receiver circuit.

9. The transceiver of claim 6, wherein said power control circuit, upon first detecting that said carrier-present signal indicates the absence of a received RF signal by the receiver circuit, disconnects said receive DC current source from the receiver circuit, and said power control circuit disconnects said transmit DC current source from the transmitter circuit, thereafter switching into said lowered-current-consumption sleep mode until said power control circuit receives the next said timer signal from said timer.

10. The transceiver of claim 9, wherein said power control circuit, upon receipt of each subsequent said timer signal from said timer, switches from said lowered-current-consumption sleep mode into said normal-current-consumption operational mode and connects said receive DC current source to the receiver circuit.

11. The transceiver of claim 9, wherein said power control circuit, upon detecting that said RF carrier-present signal indicates the presence of a received RF signal by the receiver circuit, connects said transmit DC current source to the transmitter circuit, whereupon said power control circuit switches back to said lowered-current-consumption operational sleep mode, after which, upon reception of each subsequent said timer signal from said timer, said power control circuit switches from said lowered-current-consumption sleep mode into said normal-current-consumption operational mode to detect whether said carrier-present signal still indicates the presence of said received RF carrier signal by said receiver circuit.

12. The transceiver of claim 1, wherein said power control circuit includes a counter; said power control circuit, upon reception of said timer signal from said timer, incrementing said counter, and waiting until at least two sequential said timer signals from said timer have been received before said power control circuit switches from said lowered-current-consumption sleep mode into said normal-current-consumption operational mode.

13. The transceiver of claim 1, including a current-sensing means that provides to said power control circuit, a control voltage responsive to the amount of current drawn by said transmitter circuits, wherein said primary current source is regulated to provide constant current levels to said transmitter circuits by inclusion of a current regulator circuit, in series with, and between, said primary current source and said transmitter circuits; said current regulator circuit receiving its primary power from said primary current source, and regulating the quantity of delivered current; said quantity of said delivered current being responsive to the instantaneous value of said control voltage received from said current-sensing means.

14. The transceiver of claim 1, wherein said timer signal is made available to said power control circuit at a regular interval of time that is greater than 50 milliseconds, and less than 500 milliseconds.

15. The transceiver of claim 1, wherein when said power control circuit is in said normal-current-consumption operational mode, and said receiver circuits are connected to said receive DC current source, detecting the presence of said received RF carrier signal within a period of less than 35 milliseconds.

16. The transceiver of claim 1, wherein said receive DC current source is disconnected from said at least one power-consuming element of said receiver circuits of said transceiver whenever said transmit DC current source is connected to said transmitter circuits, thereby preserving battery power by re-using any current that flows through said transmitter circuits into said at least one power-consuming element of said receiver circuits.

17. The transceiver of claim 1, wherein the receiver circuit is arranged such that current draining from a portion of the receiver circuit that is not said at least one power-consuming element of the receiver circuit, acts as a current source for said at least one power-consuming element of the receiver circuit.

18. A battery-powered radio-frequency transceiver, comprising:
a receiver circuit and a transmitter circuit, said transmitter circuit having means to reduce its own battery power consumption; and
control means for controlling the connection of DC power to said transmitter and receiver circuits;
wherein when said receiver circuit is powered by DC current, said receiver circuit detects the presence or absence of a received RF carrier signal.

19. The apparatus of claim 18, wherein said transceiver circuit reduces its own battery power consumption using the steps of:
(a) initially removing DC power from said transmitter and receiver circuits of said transceiver for a period of time, after which said transceiver connects DC power to said receiver circuits to determine whether said received RF carrier signal is detected;
(b) upon detection of the absence of received RF carrier signal, said transceiver disconnecting power to said transmitter and receiver circuits, and then waiting for said period of time;
(c) after waiting said period of time, said transceiver re-connecting DC power to said receiver circuits to allow detection of the presence or absence of said received RF carrier signal; said transceiver, upon detection of the continued absence of said received RF carrier signal, once again disconnecting DC power from said receiver circuits, and waiting again for said period of time; and
(d) said transceiver, after waiting said period of time, re-connecting DC power to said receiver circuits, and upon detection of the presence of said received RF carrier signal, connecting power to said transmitter circuits, after which said transceiver regularly waits for said period of time to verify the continued presence of said received RF carrier signal.

20. The transceiver of claim 18, wherein said period of time is greater than 50 milliseconds and less than 500 milliseconds.

21. The transceiver of claim 18, wherein, when said receiver circuits are connected to DC power, and wherein detection of the presence of said received RF carrier signal occurs within a period of less than 35 milliseconds.
